(19) United States
(12) Patent Application Publication
(10) Pub. No.: US 2024/0370864 A1
(43) Pub. Date: Nov. 7, 2024

(54) INFORMATION PROCESSING METHOD, INFORMATION PROCESSING DEVICE, AND RECORDING MEDIUM

(71) Applicant: Panasonic Intellectual Property Corporation of America, Torrance, CA (US)

(72) Inventors: Kakuya YAMAMOTO, Hyogo (JP); Ayaka NAKASAKA, Osaka (JP); Junji MICHIYAMA, Fukuoka (JP)

(21) Appl. No.: 18/776,950

(22) Filed: Jul. 18, 2024

Related U.S. Application Data
(63) Continuation of application No. PCT/JP2023/002425, filed on Jan. 26, 2023.
(60) Provisional application No. 63/307,300, filed on Feb. 7, 2022.

(51) Int. Cl. G06Q 20/38

(52) U.S. Cl. CPC G06Q 20/389

(57) ABSTRACT

An information processing method to be performed by an information processing device using a processor includes: obtaining value information owned by a user and indicating a contribution to the natural environment as an environmental value; determining, according to the environmental value indicated in the value information obtained, a function to be provided to the user who uses a virtual space generated by a computer; and providing the determined function to the user.

### CROSS REFERENCE TO RELATED APPLICATIONS

This is a continuation application of PCT International Application No. PCT/JP2023/002425 filed on Jan. 26, 2023, designating the United States of America, which is based on and claims priority of U.S. Provisional Patent Application No. 63/307,300 filed on Feb. 7, 2022. The entire disclosures of the above-identified applications, including the specifications, drawings and claims are incorporated herein by reference in their entirety.

### FIELD

The present disclosure relates to information processing methods, information processing devices, and recording media.

### BACKGROUND

There is a system that collects dynamic information of avatars and use the dynamic information for marketing when doing businesses using three-dimensional virtual spaces (refer to Patent Literature (PTL) 1).

### CITATION LIST

### Patent Literature

PTL 1: Japanese Unexamined Patent Application Publication No. 2011-216073

### SUMMARY

### Technical Problem

However, when load on information processing of a server that creates a virtual space increases, burden on the natural environment (also referred to as environmental burden) increases, which is problematic.

Thus, the present disclosure provides an information processing method in which an increase in burden on the natural environment is minimized.

### Solution to Problem

An information processing method according to one aspect of the present disclosure is an information processing method to be performed by an information processing device using a processor and includes: obtaining value information owned by a user and indicating a contribution to a natural environment as an environmental value; determining, according to the environmental value indicated in the value information obtained, a function to be provided to the user who uses a virtual space generated by a computer; and providing, to the user, the function determined.

Note that these general and specific aspects may be implemented using a system, a device, an integrated circuit, a computer program, or a computer-readable recording medium such as compact disc read-only memory (CD-ROM), or any combination of systems, devices, integrated circuits, computer programs, or recording media.

### Advantageous Effects

With an information processing method according to the present disclosure, it is possible to minimize the increase in burden on the natural environment.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating the configuration of a system according to an embodiment.

FIG. 2 is a diagram illustrating a virtual space management server according to an embodiment.

FIG. 3 is an explanatory diagram illustrating an example of a virtual space according to an embodiment.

FIG. 4 is an explanatory diagram illustrating value information according to an embodiment.

FIG. 5 is a first flowchart illustrating processes performed by a virtual space management server according to an embodiment.

FIG. 6 is a second flowchart illustrating processes performed by a virtual space management server according to an embodiment.

FIG. 7 is an explanatory diagram illustrating a mode of representation of a building in a virtual space according to an embodiment.

FIG. 8 is a sequence chart illustrating an example of processes performed by a system according to an embodiment.

FIG. 9 is a sequence chart illustrating an example of processes performed by a system according to Variation 1 of an embodiment.

FIG. 10 is an explanatory diagram illustrating a preferential function according to Variation 1 of an embodiment.

FIG. 11 is a sequence chart illustrating an example of processes performed by a system according to Variation 2 of an embodiment.

FIG. 12 is an explanatory diagram illustrating the data structure of a blockchain.

FIG. 13 is an explanatory diagram illustrating the data structure of transaction data.

### DESCRIPTION OF EMBODIMENT

### (Underlying Knowledge Forming Basis of the Present Disclosure)

In relation to the three-dimensional virtual space usage technique disclosed in the Background section, the inventors have found the problem indicated below.

A three-dimensional virtual space is created through information processing using a computer. Specifically, the positions and shapes of an item (such as a building or a land) and a person (generally referred to as an avatar) present in the three-dimensional virtual space are calculated using a computer, and image data of an image in which such item and person are visually recognizable at the positions in the three-dimensional virtual space is provided. Using a device that presents the image data of the image representing the three-dimensional virtual space, a user can visually recognize and experience the three-dimensional virtual space.

In three-dimensional virtual space, sales the transactions of items (also referred to simply as trades or transactions) are made. There are cases where a cryptocurrency which is managed using a distributed ledger is used for transactions of items in the three-dimensional virtual space.

The load on information processing necessary for creating such a three-dimensional virtual space is relatively high. Therefore, the problem is that when load on information processing of a server that creates the three-dimensional virtual space increases, burden on the natural environment increases. Furthermore, the transactions using a cryptocurrency require the process of storing, into the distributed ledger, transaction data indicating the content of transactions; the load on this process is also relatively high as in said case. Therefore, when items are traded in the three-dimensional virtual space, the increase in the environmental burden is more noticeable.

Thus, the present disclosure provides an information processing method in which an increase in burden on the natural environment is minimized.

Hereinafter, the disclosure of the present specification will be described as an example, and advantageous effects, etc., obtained from the disclosure will be explained.

(1) An information processing method to be performed by an information processing device using a processor includes: obtaining value information owned by a user and indicating a contribution to a natural environment as an environmental value; determining, according to the environmental value indicated in the value information obtained, a function to be provided to the user who uses a virtual space generated by a computer; and providing, to the user, the function determined.

According to this aspect, the information processing device determines, according to the environmental value owned by a user, a function to be provided to the user, and therefore it is possible to promote that a user who wishes to receive the function will own the environmental value. The owning of an environmental value by a user leads to a contribution to the natural environment, in other words, a reduced increase in burden that is imposed on the natural environment. Thus, with said information processing method, it is possible to minimize the increase in burden on the natural environment.

(2) In the information processing method disclosed in (1), the determining of the function includes determining whether an amount of the environmental value indicated in the value information is greater than or equal to a reference value, and when the amount of the environmental value indicated in the value information is determined to be greater than or equal to the reference value, a function of entering a specific region in the virtual space is determined as the function to be provided to the user.

According to this aspect, the information processing device provides the function of entry to the specific region in the virtual space to the user who owns the environmental value the amount of which is greater than or equal to the reference value. As a result, it is possible to promote that a user who wishes to enter the specific region in the virtual space will own the environmental value, and the increase in the environmental burden can be more easily minimized. Thus, with said information processing method, the increase in burden that is imposed on the natural environment can be more easily minimized.

(3) In the information processing method disclosed in (2), the user is a first user, the value information owned by the first user is transferred to a second user when the first user enters the specific region, and a second amount of the value information owned by the first user is further transferred to the second user when an amount of time during which the first user is in the specific region exceeds a first amount of time.

According to this aspect, in each of the cases where the first user enters the specific region and where the first user has been in the specific region for more than a first amount of time, the information processing device transfers the value information to the second user. As a result, it is possible to promote that the first user who wishes to enter the specific region in the virtual space and stay in the specific region longer will own the environmental value, and the increase in the environmental burden can be more easily minimized. Thus, with said information processing method, the increase in burden that is imposed on the natural environment can be more easily minimized.

(4) In the information processing method disclosed in any one of (1) to (3), in the determining of the function, more functions are determined as the function to be provided to the user as an amount of the environmental value indicated in the value information owned by the user increases.

According to this aspect, the information processing device provides more functions to a user who has a larger amount of environmental values. Therefore, a user who wishes to receive more functions in the virtual space contributes to promoting the owning of the environmental value and as a result, the increase in the environmental burden is more easily minimized. Thus, with said information processing method, the increase in burden that is imposed on the natural environment can be more easily minimized.

(5) In the information processing method disclosed in any one of (1) to (4), the user is a first user, and the determining of the function includes: transferring, to the first user, a non-fungible token (NFT) owned by a second user in the virtual space; and determining, as the function to be provided to the first user, a function of transferring the value information owned by the first user to the second user.

According to this aspect, the information processing device causes the first user to receive a NFT transferred in exchange for transfer of the environmental value and therefore, it is possible to promote that a user who wishes to receive a NFT (in other words, wishes to own a NFT) will own the environmental value, and the increase in the environmental burden can be more easily minimized. Thus, with said information processing method, the increase in burden that is imposed on the natural environment can be more easily minimized.

(6) In the information processing method disclosed in (5), in transferring of the value information, in a blockchain network in which transaction data related to trading of the NFT is stored, the value information is transferred by executing a smart contract including the function of transferring the value information.

According to this aspect, the information processing device performs the NFT transfer process by executing the smart contract, and therefore performs the NFT transfer process automatically (in other words, without human intervention). Thus, as compared to the case where the NFT transfer process includes human operation, the human operation is no longer necessary, and it is possible to prevent erroneous operation, unauthorized operation, or the like that may occur in the case where the human operation is included, resulting in a contribution to more appropriate transfer of a NFT. With the information processing method, the increase in burden that is imposed on the natural environment can be more easily minimized while the NFT transfer process is more properly performed.

(7) In the information processing method disclosed in (5) or (6), in transferring of the value information, an amount of the value information to be transferred from the first user to the second user is determined with reference to a predetermined association between an identifier with which the NFT is identifiable and an amount of the environmental value corresponding to the NFT, and the amount of the value information that has been determined is transferred from the first user to the second user.

According to this aspect, by referring to the association between the identifier of a NFT and the amount of the value information, the information processing device can easily determine the amount of the value information for receipt of a NFT transferred in exchange for transfer of the value information. Thus, with said information processing method, the increase in burden that is imposed on the natural environment can be more easily minimized.

(8) In the information processing method disclosed in any one of (5) to (7), in transferring of the value information, along with the transferring of the NFT owned by the second user in the virtual space to the first user, the value information and a cryptocurrency owned by the first user are transferred to the second user.

According to this aspect, the information processing device causes the first user to receive a NFT transferred in exchange for transfer of the environmental value and the cryptocurrency, therefore it is possible to promote that a user who wishes to receive a NFT will own the environmental value, and the increase in the environmental burden can be more easily minimized. Thus, with said information processing method, the increase in burden that is imposed on the natural environment can be more easily minimized.

(9) In the information processing method disclosed in any one of (1) to (8), in the determining of the function, a function of giving preferential treatment regarding entry of an avatar corresponding to the user to a specific region in the virtual space, a function of giving preferential treatment regarding appearance of the avatar in the virtual space, a function of giving preferential treatment regarding performance of communication to be provided to the user, or a function of giving preferential treatment regarding a gaming function to be provided to the user in the virtual space is determined as the function to be provided to the user.

According to this aspect, the information processing device provides, to the user who has the environmental value the amount of which is greater than or equal to the reference value, the function of changing the avatar, the function of changing the communication performance, or the function of changing the gaming performance, therefore it is possible to promote that a user who wishes to receive said function will own the environmental value, and the increase in the environmental burden can be more easily minimized. Thus, with said information processing method, the increase in burden that is imposed on the natural environment can be more easily minimized.

(10) In the information processing method disclosed in any one of (1) to (9), the value information includes, as the environmental value, a CO₂ emissions reduction amount in power generation using renewable energy or an amount of electric power generated by the power generation.

According to this aspect, by using, as the environmental value, the CO₂ emissions reduction amount in power generation using renewable energy or the amount of electric power generated using renewable energy, the information processing device can more easily minimize the increase in burden that is imposed on the natural environment.

(11) In the information processing method disclosed in (10), the value information further includes at least one of date and time of the power generation, a location of the power generation, or a digital signature of a person who has certified the environmental value.

According to this aspect, by using the value information including at least one of the date and time, the location, and the digital signature, the information processing device can more easily minimize the increase in burden that is imposed on the natural environment.

(12) In the information processing method disclosed in any one of (1) to (11), the value information includes a digital signature of a person who has certified the environmental value, and in the determining of the function, a verification process is performed on the digital signature, and the function is determined only when verification of the digital signature is successful in the verification process.

According to this aspect, the information processing device provides the function only when the verification of the digital signature is successful, and therefore it is possible to promote that a user will receive an official certification for the environmental value; in other words, an unauthorized environmental value using an environmental value that is not official can be eliminated. Thus, with said information processing method, the increase in burden that is imposed on the natural environment can be more properly minimized.

(13) An information processing device includes: an obtainer that obtains value information owned by a user and indicating a contribution to a natural environment as an environmental value; and a determiner that determines, according to the environmental value indicated in the value information obtained, a function to be provided to the user who uses a virtual space generated by a computer, and provides, to the user, the function determined.

With this aspect, advantageous effects are produced that are substantially the same as those produced by the above-described information processing method.

(14) A non-transitory computer-readable recording medium having recorded thereon a program for causing a computer to execute the information processing method disclosed in (1).

With this aspect, advantageous effects are produced that are substantially the same as those produced by the above-described information processing method.

Note that these general and specific aspects may be implemented using a system, a device, an integrated circuit, a computer program, or a computer-readable recording medium such as CD-ROM, or any combination of systems, devices, integrated circuits, computer programs, or recording media.

Hereinafter, an embodiment will be described in greater detail with reference to the Drawings.

Note that each of the embodiments described below shows a general or specific example. The numerical values, shapes, materials, structural elements, the arrangement and connection of the structural elements, steps, the processing order of the steps, etc., shown in the following embodiment are mere examples, and are not intended to limit the present disclosure. Among the structural elements in the following embodiment, structural elements not recited in any one of the independent claims which indicate the broadest concepts will be described as optional structural elements.

### EMBODIMENT

The present embodiment will describe an information processing method, etc., in which an increase in burden that is imposed on the natural environment is minimized.

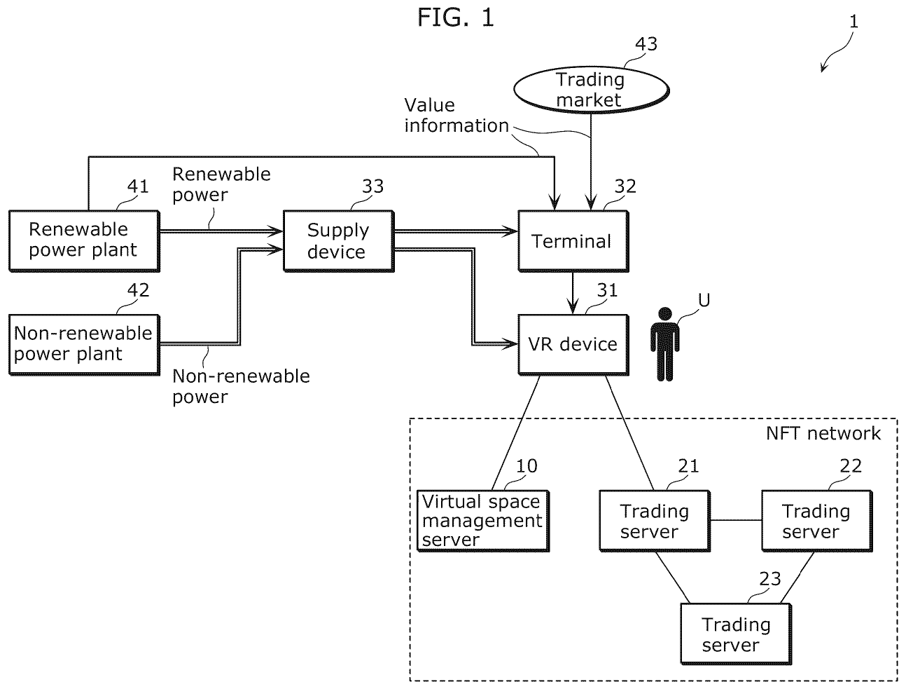

FIG. 1 is a block diagram illustrating the configuration of system 1 according to the present embodiment.

System 1 is a system that, using information indicating a contribution to the natural environment, contributes to a reduced increase in burden that is imposed on the natural environment. Information indicating a contribution to the natural environment is referred to as value information. The value information is information indicating a contribution of an individual or a group to the natural environment as an environmental value. The environmental value is managed according to an appropriate scheme. Examples of the scheme for the environmental value include J-Credit, the renewable energy certificate, and the non-fossil certificate. There are cases where a certificate indicating owning of the environmental value is used for management of the environmental value. In this case, the certificate may correspond to the value information.

The environmental value is created when power is generated using renewable energy, for example. Furthermore, transfer (including assignment or sales) of the environmental value is possible. It can also be said that the transfer of the environmental value is the transfer of environmental information.

As illustrated in FIG. 1, system 1 includes virtual space management server 10, trading servers 21, 22, 23 (also referred to as trading server 21, etc.), virtual reality (VR) device 31, terminal 32, supply device 33, renewable power plant 41, non-renewable power plant 42, and trading market 43. In FIG. 1, the flow of electric power is indicated by the double line arrow, and the flow of information is indicated by the single line arrow. VR device 31 is connected to each of virtual space management server 10, trading server 21, etc., and terminal 32 so as to allow communication therebetween.

User U is a user who experiences a virtual space.

Virtual space management server 10 is a server that is a computer that manages the virtual space. Virtual space management server 10 creates the virtual space, transmits and thus provides VR data representing the virtual space to user U, and thus contributes to allowing user U to experience the virtual space. The virtual space is a three-dimensional virtual space, for example; the following description assumes that the virtual space is a three-dimensional virtual space, but this is not limiting, and the virtual space may be a two-dimensional virtual space. Generally, the virtual space may also be referred to as a metaverse. The VR data may include image data of an image showing a scene in the virtual space and may also include sound and speech data representing sound and speech in the virtual space. There may be an item and an avatar in the virtual space. The avatar may be associated with a person in the real world.

Virtual space management server 10 allows user U to experience the virtual space using VR device 31. Virtual space management server 10 transmits VR data to VR device 31 and receives information regarding the position and posture of VR device 31 (also referred to as position information).

Furthermore, virtual space management server 10 enables trading of items in the virtual space. In trading of items, for example, when an item is transferred from a provider of the item to user U, a cryptocurrency is transferred from user U to the provider. The cryptocurrency, which is bitcoin or Ethereum, for example, is managed using the distributed ledger. As one example, the transfer of an item is managed as the transfer of a NFT using the distributed ledger; this case will be described as an example, but this is not limiting.

Virtual space management server 10 can determine a function to be provided to user U in the virtual space (also referred to as a function to be provided) and by this determination, contribute to a reduced increase in burden that is imposed on the natural environment. The determination of the function to be provided will be described later in detail.

Trading server 21 is a server that manages the transfer of a cryptocurrency using a distributed ledger. In trading server 21, the distributed ledger is stored in storage. When trading server 21 receives, from VR device 31 or the like, transaction data indicating the transfer of a cryptocurrency, trading server 21 performs the process of storing the received transaction data into the distributed ledger. The transaction data indicating the transfer of a cryptocurrency includes addresses of a destination and a source of the transfer of the cryptocurrency that have been recorded in a distributed ledger system.

Furthermore, using the distributed ledger, trading server 21 can manage the transfer of an item in the virtual space as the transfer of a NFT. When trading server 21 receives, from VR device 31 or the like, transaction data indicating the transfer of a NFT, trading server 21 performs the process of storing the received transaction data into the distributed ledger. The transaction data indicating the transfer of a NFT includes addresses of a destination and a source of the transfer of the NFT that have been recorded in the distributed ledger system.

At the time of storing new transaction data into the distributed ledger, trading server 21 stores the new transaction data into the distributed ledger in a method corresponding to the type of the distributed ledger. Trading server 21, which can transmit and receive communication data to and from other trading servers 22, 23, transmits this transaction data to other trading servers 22, 23 and causes the distributed ledgers included in other trading servers 22, 23 to store this transaction data as well. At the time of storing the transaction data, a consensus may be built according to a consensus algorithm before the transaction data is stored. The transaction data stored in the distributed ledger is managed in a tamper-resistant way using properties such as a hash value (which will be described later).

For example, when the distributed ledger is a blockchain, trading server 21 generates a block including new transaction data, builds a consensus on the generated block among trading servers 21, etc., according to the consensus algorithm, and stores said block into the distributed ledger. Note that the type of the distributed ledger is not limited to that described above; a distributed ledger of another type (for example, IOTA or a hash graph) may also be used.

Trading servers 22, 23 are substantially the same as trading server 21 and operate independently of trading server 21.

Note that a trading server group including trading servers 21, etc., can also be referred to as a distributed ledger network. The following describes an example in which the distributed ledger network includes three trading servers 21, etc., but the number of trading servers 21, etc., may be four or more.

VR device 31, which is an information processing device that presents the virtual space to user U, is owned by user U. VR device 31, which includes a central processing unit (CPU), memory, storage, a display screen, a loudspeaker, a sensor, and so on, performs information processing by the CPU executing a predetermined program using the memory. VR device 31 may include a global positioning system (GPS) receiver that receives the position of VR device 31 on the earth. VR device 31, which is mounted on the head of user U, for example, is generally referred to as VR goggles or a VR headset. VR device 31 operates using electric power supplied from supply device 33.

VR device 31 receives VR data from virtual space management server 10, displays an image showing a scene visible in the virtual space on the display screen using image data included in the VR data, and thus presents the image to user U. Furthermore, VR device 31 can cause the loudspeaker to output sound and speech audible in the virtual space using sound and speech data included in the VR data, and thus present the sound and speech to user U.

Furthermore, VR device 31 obtains the position information of VR device 31 by a sensor (such as a three-axis acceleration sensor or a three-axis gyroscope) and transmits the position information to virtual space management server 10. The transmitted position information is used by virtual space management server 10 generating VR data, and the VR data calculated in consideration of the transmitted position information is subsequently transmitted.

Furthermore, VR device 31 transmits, to virtual space management server 10, information indicating an operation performed by user U on VR device 31 (also referred to as operation information). The operation information may include, for example, an operation to select one action from options of actions in the virtual space (that are so-called a selection menu or the like). The transmitted operation information is reflected in the position information of user U in the virtual space (in other words, an avatar corresponding to user U), and VR data based on the position information in which the transmitted operation information has been reflected is subsequently transmitted.

VR device 31 owns, in the storage, value information indicating at least a portion of the environmental value owned by user U.

Terminal 32 is an information processing terminal owned by user U. Terminal 32, which includes a CPU, memory, storage, a display screen, and so on, performs information processing by the CPU executing a predetermined program using the memory. Terminal 32 is a smartphone, a tablet, a personal computer, or the like, for example. Terminal 32 operates using electric power supplied from supply device 33.

Terminal 32 holds, in the storage, value information indicating at least a portion of the environmental value owned by user U. When renewable power (to be described later) is supplied from supply device 33 to terminal 32 or VR device 31, terminal 32 obtains value information indicating the environmental value of the supplied renewable power, and stores the value information into the storage. This corresponds to transfer of the environmental value of the supplied renewable power from renewable power plant 41 to user U. Furthermore, terminal 32 can purchase and obtain the value information indicating the environmental value from trading market 43 and store the value information into the storage.

Note that virtual space management server 10 may allow user U to experience the virtual space using terminal 32. In this case, the virtual space is provided via the display screen of terminal 32. Furthermore, terminal 32 may be formed integrally with VR device 31.

Supply device 33 is a device that supplies electric power to VR device 31 and terminal 32. The electric power that is supplied by supply device 33 is either electric power generated by renewable power plant 41 (also referred to as renewable power) or electric power generated by non-renewable power plant 42 (also referred to as non-renewable power).

Note that in association with the fact that supply device 33 has supplied renewable power to VR device 31 or terminal 32, supply device 33 may transfer, to terminal 32, value information indicating the environmental value of said renewable power. More specifically, when supply device 33 supplies renewable power to (in other words, charges) VR device 31 or terminal 32, supply device 33 may transfer, to terminal 32, value information indicating the environmental value of said renewable power.

Renewable power plant 41 is a power plant that generates electric power using renewable energy. The renewable energy, which is energy that exists in nature, is solar power, wind power, hydropower, or geothermal energy, for example. It can also be said that the renewable energy is energy that can be collected sustainably from nature.

Non-renewable power plant 42 is a power plant that generates electric power using a fossil fuel or the like. Examples of the fossil fuel include oil, coal, and natural gas. It can also be said that non-renewable power plant 42 is a power plant that generates electric power using energy that is not renewable energy.

Trading market 43 is a sales and purchase market in which the value information is traded. A seller of the value information sells the value information to a purchaser of the value information via trading market 43. At the time of sale of the value information, the value information is transferred from the seller to the purchaser, and remuneration is transferred from the purchaser to the seller. The remuneration may be money or may be information (tokens, coupons, or the like) equivalent in value to money.

Note that a device group including virtual space management server 10, trading server 21, and the like, which is a device group related to NFT trading in the virtual space, can also be called a NFT network.

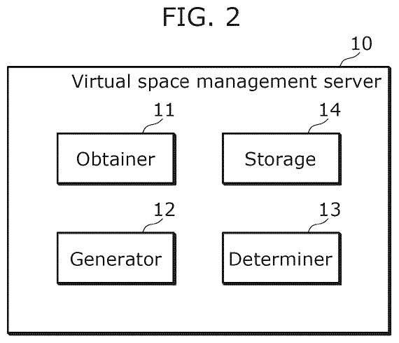

FIG. 2 is a diagram illustrating virtual space management server 10 in the present embodiment.

As illustrated in FIG. 2, virtual space management server 10 includes obtainer 11, generator 12, determiner 13, and storage 14. Obtainer 11, generator 12, and determiner 13 can be implemented by a processor (for example, a central processing unit (CPU)) (not illustrated in the drawings) included in virtual space management server 10 executing a predetermined program using memory (not illustrated in the drawings).

Obtainer 11 obtains information from VR device 31 via a network.

Specifically, obtainer 11 obtains value information owned by user U. The value information indicates the value information owned by user U. The value information may include, as an environmental value, a CO₂ emissions reduction amount (kg-CO₂, etc.) in power generation using renewable energy or the amount of electric power (Wh, etc.) generated using renewable energy. Note that the CO₂ emissions reduction amount and the amount of electric power generated can be easily converted according to predetermined conversion formulas. Note that the value information may include, in addition to the value information, at least one of the date and time on which electric power was generated, the location at which electric power was generated, and the digital signature of a person who has certified the environmental value. Details of the value information will be described later.

Obtainer 11 receives and obtains the position information or the operation information of VR device 31 from VR device 31. Obtainer 11 transmits the received position information or the received operation information of VR device 31 to generator 12.

Generator 12 generates VR data representing the virtual space. Generator 12 manages the position of an item, an avatar, or the like in the virtual space and when the item or the avatar moves, calculates and manages the position of the item or the avatar that has moved. Furthermore, generator 12 generates image data of an image showing a scene visible from a predetermined position in the virtual space, and transmits the generated image data to VR device 31 as VR data. Furthermore, generator 12 generates sound and speech data representing sound and speech (including sound, human voice, and the like) audible at a predetermined position in the virtual space, and transmits the generated sound and speech data to VR device 31 as VR data.

Generator 12 obtains the position information of VR device 31, calculates the position and posture of VR device 31 (in other words, the position and posture of user U) using the obtained position information, and generates said VR data.

Determiner 13 determines, according to the environmental value indicated in the value information obtained by obtainer 11, a function to be provided to user U who uses the virtual space (also referred to as a function to be provided), and provides the determined function to user U.

At the time of determining the function, determiner 13 can determine whether the amount of environmental values (also referred to as a first amount) indicated in the value information is greater than or equal to a reference value, and when determining that the amount of environmental values indicated in the value information is greater than or equal to the reference value, determine, as the function to be provided, a function of entry to a specific region in the virtual space (also referred to as an entry function). Entering the specific region in the virtual space corresponds to entering of an avatar to the specific region in the virtual space; it can also be said that entering the specific region in the virtual space corresponds to entering of user U to the specific region in the virtual space. The function of entry to the specific region in the virtual space is a function that causes VR device 31 to present, to user U, an image showing a scene inside the specific region or causes VR device 31 to present sound and speech inside the specific region to user U.

At this time, in the case where user U (corresponding to the first user) enters the specific region, the value information owned by user U may be transferred to another user (the second user). Furthermore, when an amount of time during which user U is in the specific region exceeds the first amount of time, a second amount of the value information owned by user U may be transferred to the other user. The other user may be an operator of the virtual space, for example. Note that the operator of the virtual space may also be called a manager, a host, or the like. The first amount and the second amount may be the same or different. Furthermore, each of the first amount and the second amount of the environmental value per unit time may be increased or decreased with time. When the environmental value per unit time increases with time, user U who has been logged in to the virtual space for a relatively long period of time will be encouraged to log out, and thus the power consumption of virtual space management server 10 will be reduced, resulting in a contribution to minimizing the increase in the environmental burden. When the environmental value per unit time decreases with time, user U who has been logged in the virtual space will remain logged in, and thus the virtual space will be continuously used, resulting in a contribution to minimizing the increase in the environmental burden while promoting trading in the virtual space.

Furthermore, at the time of determining a function, determiner 13 may determine that more functions are to be provided to user U as the amount of the environmental value indicated in the value information owned by user U increases.

Furthermore, determiner 13 may transfer a NFT in exchange for the transfer of the value information. Specifically, at the time of determining a function, determiner 13 may determine, as the function to be provided, the function of transferring a non-fungible token (NFT) owned by another user in the virtual space to user U and transferring the value information owned by user U to the other user. Transaction data indicating the transfer of a cryptocurrency includes addresses of a destination and a source of the transfer of the cryptocurrency that have been recorded in the distributed ledger system. Transaction data indicating the transfer of the NFT includes addresses of a destination and a source of the transfer of the NFT that have been recorded in the distributed ledger system.

At this time, in the distributed ledger network in which transaction data related to NFT trading is stored, the value information can be transferred by executing a smart contract including the function of transferring the value information. In this case, the contract code of the smart contract including the function of transferring the value information has been stored in the distributed ledger in said distributed ledger network, and said smart contract can be executed by storing, into the distributed ledger, transaction data including a command for executing said smart contract.

Furthermore, at the time of transferring the value information, the amount of the value information to be transferred from user U to the other user may be determined with reference to a predetermined association between an identifier with which a NFT can be identified and an amount of value information that corresponds to the NFT.

Note that the NFT may be transferred in exchange for the value information and the cryptocurrency. Specifically, at the time of transferring the value information, determiner 13 may determine that the NFT in the virtual space is to be transferred from the other user to user U and that the value information and the cryptocurrency owned by user U is to be transferred to the other user.

Storage 14, which is a storage device in which information is stored, is implemented using volatile memory (such as random access memory (RAM)), non-volatile storage (such as a hard disk drive (HDD) or a solid state drive (SSD)), or the like.

In storage 14, value information indicating the environmental value owned by the operator of the virtual space is stored. Furthermore, a program that causes a processor to execute a function of virtual space management server 10 is stored in storage 14.

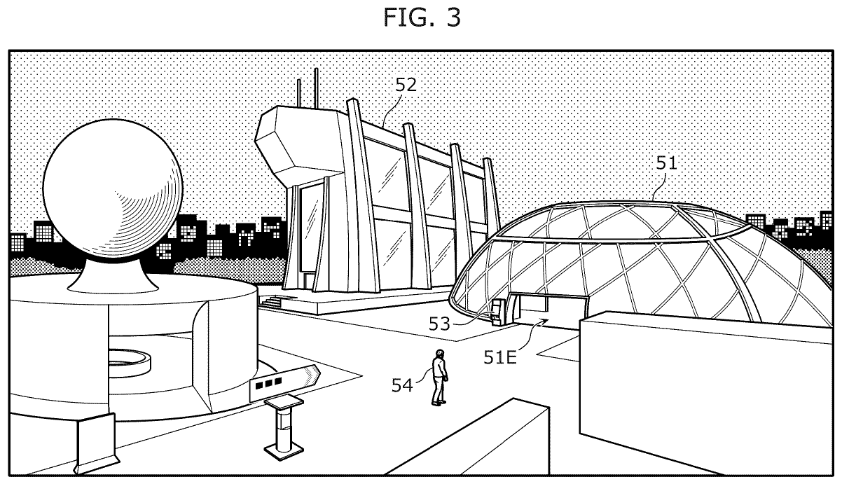

FIG. 3 is an explanatory diagram illustrating an example of the virtual space according to the present embodiment. The virtual space illustrated in FIG. 3 is an example of the virtual space generated by virtual space management server 10.

There are buildings 51, 52 in the virtual space illustrated in FIG. 3. Furthermore, there is vending machine 53 near entrance/exit 51E to building 51. Moreover, there is avatar 54 that moves toward building 51. Note that each of items such as building 51 or avatar 54 in the virtual space is a mere example.

Avatar 54 is a character in the virtual space that corresponds to user U in the real world.

Building 51, which is a building in the virtual space, is a facility in which avatars 54 gather together to communicate with each other, for example. When avatar 54 enters building 51, an image showing a scene inside building 51 is presented to user U, and sound and speech inside building 51 are also presented to user U.

Building 52, which is a building in the virtual space, is a building different from building 51.

Vending machine 53 is a vending machine for environmental values in the virtual space. User U can purchase the environmental value from vending machine 53 using a cryptocurrency.

When user U purchases the environmental value from vending machine 53, the environmental value is transferred from a manager of vending machine 53 to user U, and the cryptocurrency is transferred from user U to the manager of vending machine 53. The manager of vending machine 53 may be the operator of the virtual space or may be another person.

For example, there are cases where a condition that a visitor is required to own a reference amount of environmental values is set as a condition for entry into building 51. There are also cases where a condition that a visitor is required to transfer a reference amount of environmental values to the operator of the virtual space is set as a condition for entry into building 51. In such cases, when user U does not own the reference amount of environmental values, user U can purchase the environmental value from vending machine 53 and thus own the reference amount of environmental values, then user U is allowed to enter building 51.

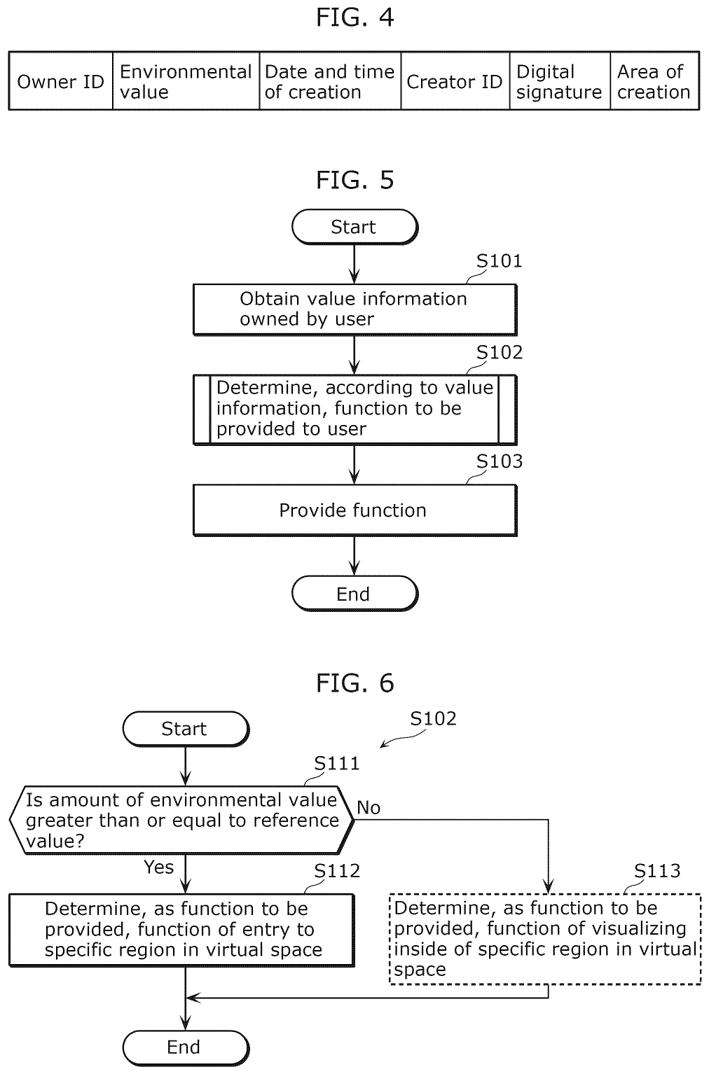

FIG. 4 is an explanatory diagram illustrating the configuration of the value information according to the present embodiment. The value information is information indicating the environmental value. The environmental value is generated at the time of generation of renewable power, for example, and is associated with the renewable power.

As illustrated in FIG. 4, the value information includes owner ID, the environmental value, a date and time of creation, creator ID, a digital signature, and an area of creation.

The owner ID is an identifier with which a person who owns the environmental value indicated in this value information can be uniquely identified.

The environmental value is information indicating the type and the amount of environmental values indicated in this value information. When there is an association between the environmental value and the renewable power generated by renewable power plant 41, the environmental value is a CO₂ emissions reduction amount (kg-CO₂, etc.) in the power generation or the amount of electric power (Wh, etc.) generated.

The date and time of creation is the date and time on which the environmental value indicated in this value information was created. When there is an association between the environmental value and the renewable power generated by renewable power plant 41, the date and time correspond to the date and time on which the electric power was generated.

The creator ID is an identifier with which a person who has created the environmental value indicated in this value information can be uniquely identified. When the environmental value is created as a result of power generation by renewable power plant 41, the creator ID is the identifier of renewable power plant 41.

The digital signature is the digital signature of a person who has certified the environmental value indicated in this value information. When the environmental value is created as a result of power generation by renewable power plant 41, for example, the person who has certified the environmental value indicated in this value information may be renewable power plant 41 that has generated the electric power. Note that the person who has certified the environmental value indicated in this value information may be an organization that certifies the environmental value.

The area of creation is information indicating an area of creation of the environmental value indicated in this value information. The area of creation indicates said area on a per country or state basis, for example.

The following will describe processes performed by virtual space management server 10.

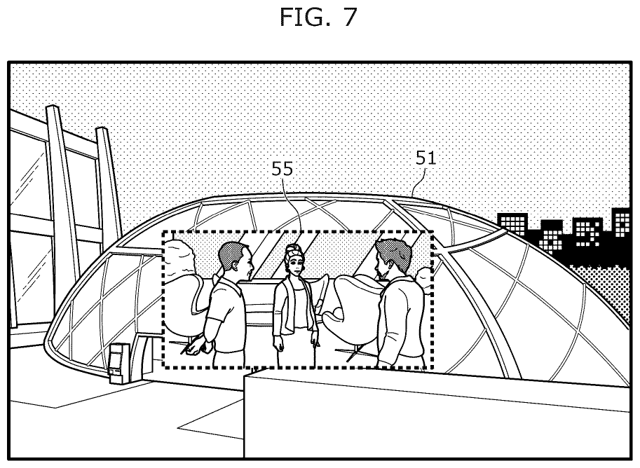

FIG. 5 is a first flowchart illustrating the processes performed by virtual space management server 10 according to the present embodiment. FIG. 6 is a second flowchart illustrating the processes performed by virtual space management server 10 according to the present embodiment. FIG. 7 is an explanatory diagram illustrating a mode of representation of building 51 in the virtual space according to the present embodiment. With reference to FIG. 5, FIG. 6, and FIG. 7, the determination of a function to be provided to user U by virtual space management server 10 will be described.

As illustrated in FIG. 5, in Step S101, obtainer 11 obtains the value information owned by user U.

In Step S102, according to the value information obtained by obtainer 11 in Step S101, determiner 13 determines a function to be provided to user U.

In Step S103, determiner 13 controls virtual space management server 10 so that the function determined in Step S102 is provided to user U. When Step S103 is completed, the series of processes illustrated in FIG. 5 comes to an end.

The processes illustrated in FIG. 6 are details of the process illustrated in in Step S102 in FIG. 5.

In Step S111, determiner 13 determines whether the amount of environmental values indicated in the value information obtained in Step S101 is greater than or equal to a reference value. When the amount of environmental values is determined to be greater than or equal to the reference value (Yes in Step S111), the processing proceeds to Step S112, and otherwise (No in Step S111), the processing proceeds to Step S113.

Note that in Step S111, determiner 13 may further perform the process of verifying the digital signature included in the value information. In this case, when the amount of environmental values is determined to be greater than or equal to the reference value and the verification of the digital signature is successful in the verification process, the processing proceeds to Step S112, and otherwise, the processing proceeds to Step S113. This allows determiner 13 to determine a function to be provided only when the verification of the digital signature included in the value information is successful.

Note that in Step S111, determiner 13 may further perform authentication using the date and time of creation of the environmental value. In this case, when the amount of environmental values is determined to be greater than or equal to the reference value and the date and time of creation of the environmental value are determined to be within a predetermined length of time (for example, two to three years) from the present, the processing proceeds to Step S112, and otherwise, the processing proceeds to Step S113. This makes it possible to block the use of an environmental value when the time elapsed between creation of the environmental value and the present is too long. This is because when the time elapsed between creation of an environmental value and the present is too long, the electric power associated with the environmental value and the electric power consumed by VR device 31 or terminal 32 are relatively less related, resulting in relatively less advantage in minimizing the increase in burden that is imposed on the natural environment.

Note that in Step S111, determiner 13 may further perform authentication using the area of creation of the environmental value. In this case, when the amount of environmental values is determined to be greater than or equal to the reference value and the area of creation of the environmental value is determined to be the same as a country in which VR device 31 is located (in other words, a country in which user U is located), the processing proceeds to Step S112, and otherwise, the processing proceeds to Step S113. The country in which VR device 31 is located can be obtained using the GPS receiver. This makes it possible to block the use of an environmental value when the area of creation of the value information is too far from user U. This is because when the area of creation of the value information is too far from user U, the electric power associated with the environmental value and the electric power consumed by VR device 31 or terminal 32 are relatively less related, resulting in relatively less advantage in minimizing the increase in burden that is imposed on the natural environment.

In Step S112, determiner 13 determines the function of entry to the specific region in the virtual space as the function to be provided.

In Step S113, determiner 13 can determine, as the function to be provided, the function of visualizing the inside of the specific region in the virtual space. The function of visualizing the inside of the specific region is a function that allows the inside of the specific region to be visualized in an image of the specific region viewed from the outside thereof in the case where the inside of the specific region is not visible from the outside thereof.

One example of the specific region is building 51 (refer to FIG. 3). In FIG. 3, with walls separating the inside from the outside, building 51 is configured so that the inside thereof is not visible from the outside. FIG. 7 shows an image of building 51 the inside of which has been visualized. In FIG. 7, image 55 showing a scene inside building 51 is superimposed on building 51, and thus the inside of building 51 is visualized. When the inside of building 51 is visualized, user U may wish to enter building 51, meaning that this may serve as a motivation to purchase the environmental value to enter building 51.

Note that in Step S113, determiner 13 may control VR device 31 so that VR device 31 displays the amount of environmental values required to reach the reference value.

Note that Step S113 is not essential and does not need to be performed.

When Step S112 or Step S113 is completed, the series of processes illustrated in FIG. 6 comes to an end.

In this manner, virtual space management server 10 can minimize the increase in burden that is imposed on the natural environment.

The following will describe processes performed by system 1 according to the present embodiment.

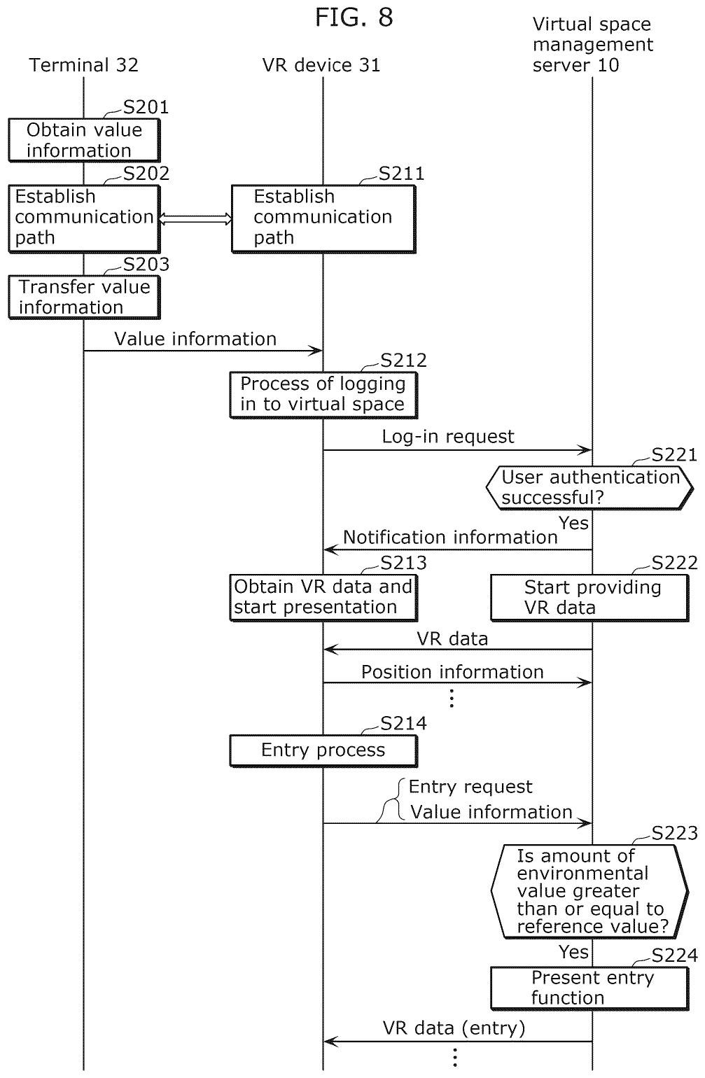

FIG. 8 is a sequence chart illustrating an example of processes performed by system 1 according to the present embodiment. FIG. 8 illustrates a series of processes from obtaining value information (specifically, an environmental value) by terminal 32 until a function is provided to user U by using the value information. The function to be provided to user U is an entry function that enables entry to the specific region in the virtual space.

In Step S201, terminal 32 obtains value information. For example, when user U purchases renewable power supplied from renewable power plant 41 and terminal 32 or VR device 31 operates using the renewable power, the environmental value to be obtained is environmental information including, as an environmental value, a CO₂ emissions reduction amount in generation of the renewable power or the amount of the renewable power. Furthermore, there are cases where user U purchases value information from trading market 43 and thus terminal 32 obtains the value information.

In Step S202, terminal 32 establishes a communication path to be used to communicate with VR device 31. The communication path may be, for example, a Bluetooth (registered trademark) or Wi-Fi (registered trademark) communication path. At this time, VR device 31 establishes a communication path to be used to communicate with terminal 32 (Step S211).

In Step S203, terminal 32 transfers the value information to VR device 31. In the transfer of the value information, the communication path established in Steps S202, S211 may be used. Note that when a person owning terminal 32 and a person owning VR device 31 are the same, transaction data related to the transfer of the value information does not need to be stored into trading server 21, etc. In contrast, when a person owning terminal 32 and a person owning VR device 31 are different, transaction data related to the transfer of the value information is stored into trading server 21, etc.

In Step S212, VR device 31 performs the process of logging in to the virtual space. In the process of logging in, VR device 31 transmits, to virtual space management server 10, a log-in request including authentication information for user U to log in to the virtual space (for example, user ID and a password of user U). Virtual space management server 10 receives the log-in request transmitted from VR device 31.

In Step S221, virtual space management server 10 authenticates user U using the authentication information included in the log-in request received in Step S212. When the authentication of user U is successful (Yes in Step S221), notification information indicating that the authentication is successful is transmitted to VR device 31. VR device 31 receives the notification information transmitted thereto. Note that when the authentication of user U is unsuccessful (not indicated in the drawings), virtual space management server 10 stops the processing; in other words, the processes following Step S221 in FIG. 8 are not performed.

In Step S222, virtual space management server 10 starts continuous transmission of VR data representing the virtual space to VR device 31. Furthermore, virtual space management server 10 receives the position information and the operation information from VR device 31, calculates the position and the posture of VR device 31 by using the received position information and the received operation information, thus generates new VR data, and keeps transmitting the new VR data to VR device 31.

In Step S213, VR device 31 receives the VR data continuously transmitted from virtual space management server 10, and presents an image and speech and sound based on the VR data to user U. Furthermore, VR device 31 can continuously transmit, to virtual space management server 10, the position information and the operation information of VR device 31 obtained by the sensor.

In Step S214, VR device 31 performs the process of causing avatar 54 to enter a specific region in the virtual space (also referred to as an entry process). The specific region is a region inside building 51, for example. The entry process can be performed when user U performs, on VR device 31, an operation to cause avatar 54 to enter building 51.

In the entry process, VR device 31 transmits at least a request for entering the specific region (also referred to as an entry request) to virtual space management server 10. Along with the transmission of the entry request, VR device 31 transmits the value information to virtual space management server 10. Virtual space management server 10 receives the entry request and the value information. Step S214 corresponds to Step S101 (refer to FIG. 5).

In Step S223, virtual space management server 10 determines whether the amount of environmental values indicated in the value information received in Step S214 is greater than or equal to the reference value, and when the amount of environmental values is determined to be greater than or equal to the reference value (Yes in Step S223), the processing proceeds to Step S224. Step S223 corresponds to Step S111 (refer to FIG. 6). When the amount of environmental values is not determined to be greater than or equal to the reference value (not indicated in the drawings), virtual space management server 10 stops the processing; in other words, the processes following Step S223 in FIG. 8 are not performed.

In Step S224, virtual space management server 10 provides the entry function. Specifically, in response to the entry request transmitted in Step S214, virtual space management server 10 permits the entry of avatar 54 into building 51, and transmits, to VR device 31, VR data including image data showing a scene inside building 51 and sound and speech data representing sound and speech inside building 51. User U can view the image of the scene inside building 51 that is represented by the image data included in the VR data and can also listen to the sound and speech inside building 51 that are represented by the sound and speech data included in the VR data. This is the action of virtual space management server 10 providing a function that allows user U to enter the specific region. Step S224 corresponds to Step S103 (refer to FIG. 5).

Note that virtual space management server 10 can also provide a function that allows user U to log in to the virtual space (also referred to as a log-in function) as the function to be provided. In this case, in Step S212 described above, VR device 31 transmits, together with the log-in request, value information indicating the environmental value owned by user U (in other words, the value information held by VR device 31). Subsequently, in Step S221 described above, along with the authentication of user U, virtual space management server 10 determines whether the amount of environmental values indicated in the value information is greater than or equal to the reference value, and when the authentication of user U is successful and the amount of environmental values is determined to be greater than or equal to the reference value, virtual space management server 10 transmits the notification information to VR device 31.

In this manner, virtual space management server 10 can minimize the increase in burden that is imposed on the natural environment.

### Variation 1 of Embodiment

The present variation will describe another mode of an information processing method, etc., in which an increase in burden that is imposed on the natural environment is minimized. In the information processing method according to the present variation, a more preferential function than usual is provided to a user, and thus the increase in burden that is imposed on the natural environment is minimized.

The configuration of a system according to the present variation is substantially the same as that of system 1 according to the above-described embodiment.

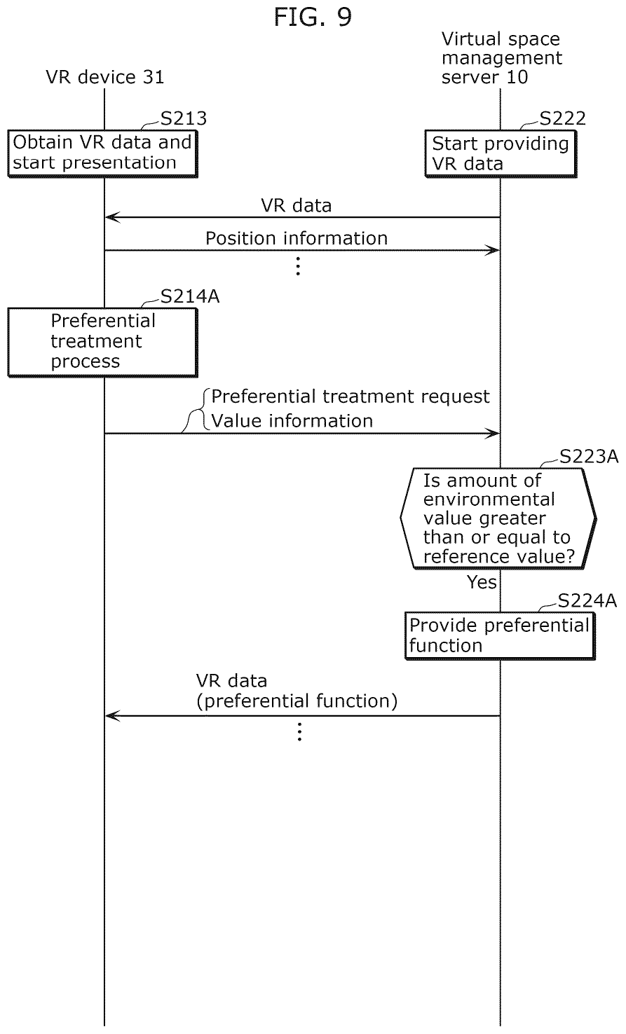

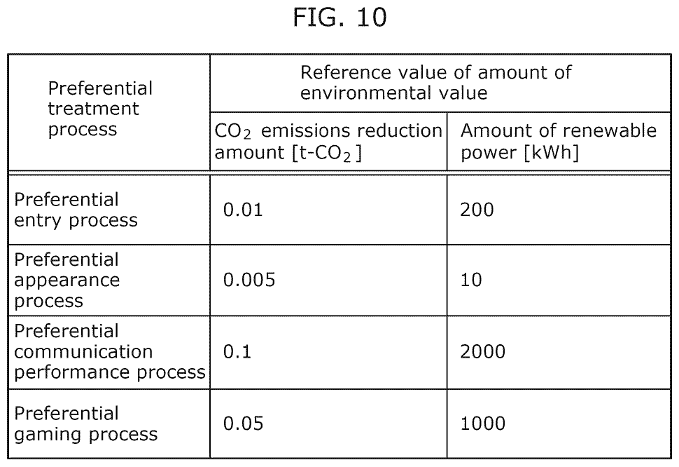

FIG. 9 is a sequence chart illustrating an example of processes performed by the system according to the present variation. FIG. 10 is an explanatory diagram illustrating a preferential function according to the present variation. With reference to FIG. 9 and FIG. 10, the system according to the present variation will be described.

The sequence chart illustrated in FIG. 9 shows the processes performed by VR device 31 and virtual space management server 10 after Steps S213 and S222 in FIG. 8. Note that processes that are the same as the processes illustrated in FIG. 8 are assigned the same reference signs and as such, detailed description thereof will be omitted.

Virtual space management server 10 starts transmitting VR data to VR device 31, VR device 31 starts presenting the VR data, and then VR device 31 performs the process of giving preferential treatment regarding the function to be provided to user U who uses the virtual space (also referred to as a preferential treatment process) (Step S214A). Examples of the preferential treatment process may include the process of giving preferential treatment regarding the entry of avatar 54 (or user U) to the specific region in the virtual space (also referred to as a preferential entry process), the process of giving preferential treatment regarding the appearance of avatar 54 (also referred to as a preferential appearance process), the process of giving preferential treatment regarding the performance of communication to be provided to user U (also referred to as a preferential communication performance process), and the process of giving preferential treatment regarding a gaming function to be provided to user U in the virtual space (also referred to as a preferential gaming process) (refer to FIG. 10). When user U performs, on VR device 31, an operation to request preferential treatment, the preferential treatment process may be performed.

In the preferential treatment process, VR device 31 transmits at least a request for preferential treatment regarding the function (also referred to as a preferential treatment request) to virtual space management server 10. Along with the transmission of the preferential treatment request, VR device 31 transmits the value information to virtual space management server 10. Virtual space management server 10 receives the preferential treatment request and the value information. Step S214A corresponds to Step S101 (refer to FIG. 5).

In Step S223A, virtual space management server 10 determines whether the amount of environmental values indicated in the value information received in Step S214A is greater than or equal to the reference value, and when the amount of environmental values is determined to be greater than or equal to the reference value (Yes in Step S223A), the processing proceeds to Step S224A. Step S223A corresponds to Step S111 (refer to FIG. 6). When the amount of environmental values is not determined to be greater than or equal to the reference value (not indicated in the drawings), virtual space management server 10 stops the processing; in other words, the processes following Step S223A in FIG. 9 are not performed.

The reference value of the amount of environmental values is determined for each target that is given preferential treatment. The reference value of the amount of environmental values may be set higher as the power consumption (in other words, the amount of information processing) of virtual space management server 10 required to perform the preferential treatment process increases. Furthermore, the reference value of the amount of environmental values may be set higher as user U wishes more for preferential treatment.

An example of the reference value of the amount of environmental values is shown in FIG. 10. In FIG. 10, the reference value of the amount of environmental values is associated with each preferential treatment process. Note that the look-up table illustrated in FIG. 10 may be generated by virtual space management server 10 or may be obtained by virtual space management server 10 from another device.

For example, the reference value of the amount of environmental values required for the entry process as the preferential treatment process is 0.01 t-CO₂ as the CO₂ emissions reduction amount and is 200 kWh as the amount of renewable power.

Similarly, the reference value of the amount of environmental values required for the preferential appearance process, the preferential communication performance process, and the preferential gaming process as the preferential treatment process is 0.005 t-CO₂, 0.1 t-CO₂, and 0.05 t-CO₂, respectively, as the CO₂ emissions reduction amount and is 10 kWh, 2000 kWh, and 1000 kWh, respectively, as the amount of renewable power.

In Step S224A, virtual space management server 10 transmits the VR data to VR device 31 in a mode in which the function requested to be given preferential treatment according to the preferential treatment request is preferentially treated. Step S224A corresponds to Step S103 (refer to FIG. 5).

For example, when the preferential treatment process is the preferential entry process, virtual space management server 10 provides, to user U, the function of giving preferential treatment regarding the entry of avatar 54. Specifically, virtual space management server 10 transmits, to VR device 31, VR data in which the entry of avatar 54 is preferentially treated (for example, avatar 54 has entered a specific region (a specific land or room or a very important person (VIP) area), avatar 54 is allowed to sit in a priority seat, or avatar 54 is allowed to ride in a sophisticated vehicle).

For example, when the preferential treatment process is appearance virtual the preferential process, space management server 10 provides, to user U, the function of giving preferential treatment regarding the appearance of avatar 54. Specifically, virtual space management server 10 transmits, to VR device 31, VR data in which the appearance of avatar 54 is preferentially treated (for example, an item such as a badge has been added to avatar 54, the color of a shadow or the contour of avatar 54 is different from a normal one, or the image resolution of avatar 54 is higher than normal image resolution).

Furthermore, when the preferential treatment process is the preferential communication performance process, virtual space management server 10 provides, to user U, the function of giving preferential treatment regarding the performance of communication. Specifically, virtual space management server 10 transmits, to VR device 31, VR data in which the performance of communication is preferentially treated (for example, there are more communication partners than usual, the avatar is displayed at high speed, or the avatar can move at high speed).

Furthermore, when the preferential treatment process is the preferential gaming process, virtual space management server 10 provides, to user U, the function of giving preferential treatment regarding the gaming function. Specifically, virtual space management server 10 transmits, to VR device 31, VR data in which the gaming function is preferentially treated (for example, the win rate in a game is higher than usual, the range of bouts (such as the number of bouts) in a game is higher than usual, or the score or bet for a bout has increased using an environment, social, governance (ESG) investor fund).

In this manner, by providing a more preferential function than usual to user U, virtual space management server 10 can minimize the increase in burden that is imposed on the natural environment.

### Variation 2 of Embodiment

The present variation will describe another mode of an information processing method, etc., in which an increase in burden that is imposed on the natural environment is minimized. In the information processing method according to the present variation, the function of purchasing a NFT in the virtual space is provided to a user, and thus the increase in burden that is imposed on the natural environment is minimized.

The configuration of a system according to the present variation is substantially the same as that of system 1 according to the above-described embodiment.

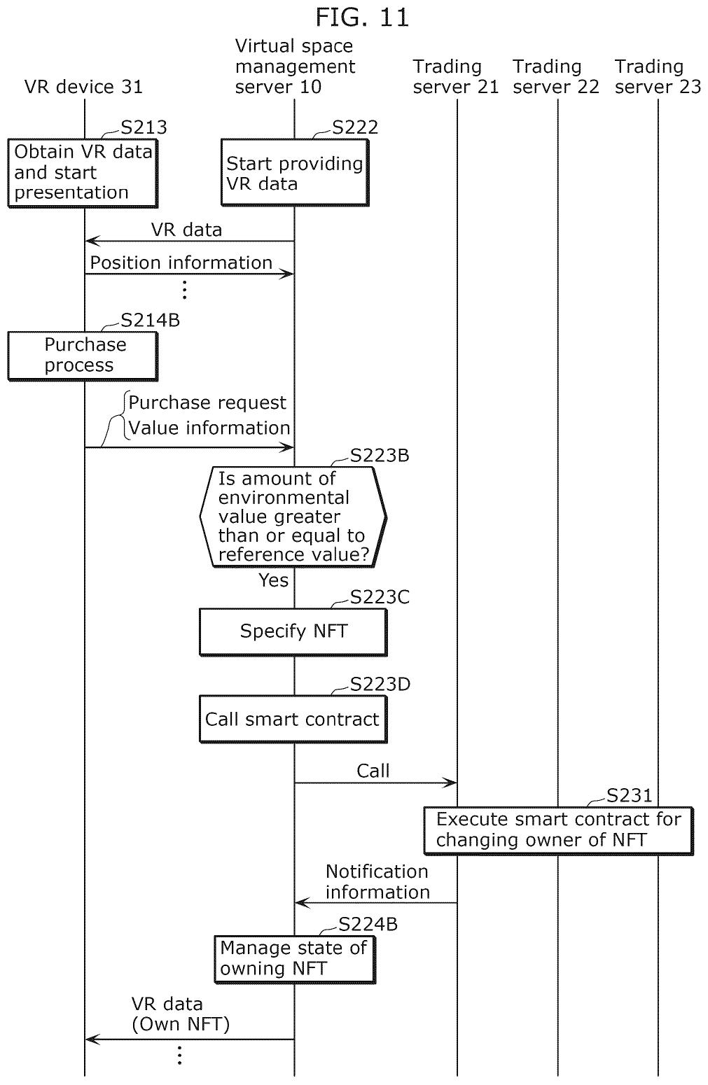

FIG. 11 is a sequence chart illustrating an example of processes performed by the system according to the present variation. The sequence chart illustrated in FIG. 11 shows the processes performed by VR device 31 and virtual space management server 10 after Steps S213 and S222 in FIG. 8. Note that processes that are the same as the processes illustrated in FIG. 8 are assigned the same reference signs and as such, detailed description thereof will be omitted.

Virtual space management server 10 starts transmitting VR data to VR device 31, VR device 31 starts presenting the VR data, and then VR device 31 performs a process in which user U purchases a NFT in the virtual space (also referred to as a purchase process) (Step S214B).

In the purchase process, VR device 31 transmits at least a NFT purchase request (also referred to as a purchase request) to virtual space management server 10. The purchase request includes the ID of a NFT to be purchased (specifically, an identifier with which the NFT can be uniquely identified). Along with the transmission of the purchase request, VR device 31 transmits the value information to virtual space management server 10. Virtual space management server 10 receives the purchase request and the value information. Step S214B corresponds to Step S101 (refer to FIG. 5).

In Step S223B, virtual space management server 10 determines whether the amount of environmental values indicated in the value information received in Step S214B is greater than or equal to the reference value, and when the amount of environmental values is determined to be greater than or equal to the reference value (Yes in Step S223B), the processing proceeds to Step S223C. Step S223B corresponds to Step S111 (refer to FIG. 6). The reference value of the amount of environmental values may be determined as a value required for the NFT purchase request. When the amount of environmental values is not determined to be greater than or equal to the reference value (not indicated in the drawings), virtual space management server 10 stops the processing; in other words, the processes following Step S223B in FIG. 11 are not performed.

Note that the reference value used in Step S223B may be a reference value that varies day-to-day. For example, the reference value used in Step S223B may be determined in proportion to a fee required for NFT transaction (so-called a gas fee).

In Step S223C, using the ID of the NFT included in the purchase request received in Step S223B, virtual space management server 10 specifies the NFT to be purchased.

In Step S223D, virtual space management server 10 calls a smart contract including the function of transferring the ownership of the NFT specified in Step S223C. The contract code of said smart contract is stored in the distributed ledger held by trading server 21, etc. Specifically, virtual space management server 10 generates transaction data including a command for calling said smart contract and transmits the transaction data to trading server 21, etc.

In Step S231, each of trading servers 21, etc., receives the transaction data transmitted in Step S223D, stores the transaction data into the distributed ledger, and at this time, executes the smart contract to be called. Trading server 21, etc., changes the owner of the NFT by executing the smart contract and then transmits, to virtual space management server 10, notification information indicating that the owner of the NFT has been changed. Since the ownership of the NFT is transferred using the smart contract, the transfer is automatically and safely performed without the intervention of other persons or other systems. Thus, the transfer of the ownership of the NFT can be properly managed.

In Step S224B, virtual space management server 10 manages the state where user U owns the NFT. Furthermore, virtual space management server 10 transmits, to VR device 31, VR data indicating the state where user U owns the NFT in the virtual space. Step S224B corresponds to Step S103 (refer to FIG. 5).

In this manner, by providing the function of purchasing a NFT in the virtual space to user U, virtual space management server 10 can minimize the increase in burden that is imposed on the natural environment.

### Additional Comments

The following are additional comments on the distributed ledger according to the above-described embodiment or variations. A blockchain will be described herein as an example of the distributed ledger, but the same is true for other distributed ledgers.

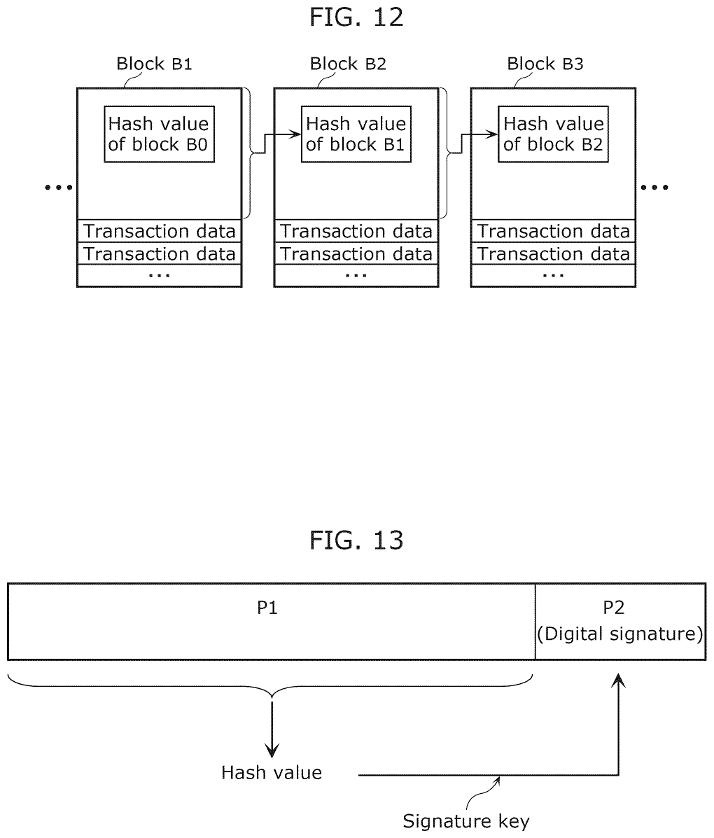

FIG. 12 is an explanatory diagram illustrating the data structure of a blockchain.

A blockchain is made up of blocks, each of which is a recording unit of the blockchain, linked together in the form of a chain. Each of the blocks includes a plurality of items of transaction data and a hash value of an immediately preceding block. Specifically, block B2 includes the hash value of previous block B1. Furthermore, a hash value calculated using the hash value of block B1 and the plurality of items of transaction data included in block B2 is included in block B3 as the hash value of block B2. In this manner, blocks are linked together in the form of a chain while including the content of previous blocks as hash values; thus, the recorded transaction data is effectively prevented from being tempered with.

If previous transaction data is changed, the hash value of the block becomes different from the original value, meaning that in order to make the block tampered with look correct, all the subsequent blocks need to be recreated, which is an extremely difficult task in practice. Using this feature, it is ensured that the blockchain is tamper-proof.

FIG. 13 is an explanatory diagram illustrating the data structure of transaction data.

The transaction data illustrated in FIG. 13 includes transaction body P1 and digital signature P2. Transaction body P1 is a data body included in said transaction data. Digital signature P2 is generated using a signing key of a creator of said transaction data for the hash value of transaction body P1; more specifically, digital signature P2 is generated by encrypting said hash value with a private key of the creator of said transaction data. Examples of the type of digital signature include the elliptic curve digital signature algorithm (ECDSA), CRYSTALS-Dilithium, Falcon, and SPHINCS+.

Because of including digital signature P2, the transaction data is virtually impossible to tamper with. This is because tampering with the transaction data will result in unsuccessful verification using digital signature P2, which reveals that the transaction data has been tampered with. Thus, transaction body P1 is protected from tampering.

Note that in the above-described embodiment or variations, each of the structural elements may be configured in the form of an exclusive hardware product, or may be realized by executing a software program suitable for the structural element. Each of the structural elements may be realized by means of a program executing unit, such as a CPU or a processor, reading and executing the software program recorded on a recording medium such as a hard disk or semiconductor memory. Here, the software program for realizing the information processing device (specifically, the virtual space management server) or the like according to each of the above-described embodiment and variations is a program described below.

Specifically, this program causes a computer to perform an information processing method that is to be performed by an information processing device using a processor and includes: obtaining value information owned by a user and indicating a contribution to a natural environment as an environmental value; determining, according the to environmental value indicated in the value information obtained, a function to be provided to the user who uses a virtual space generated by a computer; and providing, to the user, the function determined.

The information processing device (specifically, the virtual space management server) or the like according to one or more aspects has been described thus far based on the embodiment, but the present disclosure is not limited to this embodiment. Various modifications to the present embodiment and forms configured by combining structural elements in different embodiments that can be conceived by those skilled in the art may be included within the scope of one or more aspects as long as these do not depart from the essence of the present disclosure.

### INDUSTRIAL APPLICABILITY

The present disclosure is applicable to an information processing device that generates a virtual space.

1. An information processing method to be performed by an information processing device using a processor, the information processing method comprising:
obtaining value information owned by a user and indicating a contribution to a natural environment as an environmental value;
determining, according to the environmental value indicated in the value information obtained, a function to be provided to the user who uses a virtual space generated by a computer; and
providing, to the user, the function determined.

2. The information processing method according to claim 1, wherein
the determining of the function includes:
determining whether an amount of the environmental value indicated in the value information is greater than or equal to a reference value, and
when the amount of the environmental value indicated in the value information is determined to be greater than or equal to the reference value, a function of entering a specific region in the virtual space is determined as the function to be provided to the user.

3. The information processing method according to claim 2, wherein
the user is a first user,
the value information owned by the first user is transferred to a second user when the first user enters the specific region, and
a second amount of the value information owned by the first user is further transferred to the second user when an amount of time during which the first user is in the specific region exceeds a first amount of time.

4. The information processing method according to claim 1, wherein
in the determining of the function,
more functions are determined as the function to be provided to the user as an amount of the environmental value indicated in the value information owned by the user increases.

5. The information processing method according to claim 1, wherein
the user is a first user, and
the determining of the function includes:
transferring, to the first user, a non-fungible token (NFT) owned by a second user in the virtual space; and
determining, as the function to be provided to the first user, a function of transferring the value information owned by the first user to the second user.

6. The information processing method according to claim 5, wherein
in transferring of the value information,
in a blockchain network in which transaction data related to trading of the NFT is stored, the value information is transferred by executing a smart contract including the function of transferring the value information.

7. The information processing method according to claim 5, wherein
in transferring of the value information,
an amount of the value information to be transferred from the first user to the second user is determined with reference to a predetermined association between an identifier with which the NFT is identifiable and an amount of the environmental value corresponding to the NFT, and
the amount of the value information that has been determined is transferred from the first user to the second user.

8. The information processing method according to claim 5, wherein
in transferring of the value information,
along with the transferring of the NFT owned by the second user in the virtual space to the first user, the value information and a cryptocurrency owned by the first user are transferred to the second user.

9. The information processing method according to claim 1, wherein
in the determining of the function,
a function of giving preferential treatment regarding entry of an avatar corresponding to the user to a specific region in the virtual space, a function of giving preferential treatment regarding appearance of the avatar in the virtual space, a function of giving preferential treatment regarding performance of communication to be provided to the user, or a function of giving preferential treatment regarding a gaming function to be provided to the user in the virtual space is determined as the function to be provided to the user.

10. The information processing method according to claim 1, wherein
the value information includes, as the environmental value, a CO₂ emissions reduction amount in power generation using renewable energy or an amount of electric power generated by the power generation.

11. The information processing method according to claim 10, wherein
the value information further includes:
at least one of date and time of the power generation, a location of the power generation, or a digital signature of a person who has certified the environmental value.

12. The information processing method according to claim 1, wherein
the value information includes a digital signature of a person who has certified the environmental value, and
in the determining of the function,
a verification process is performed on the digital signature, and the function is determined only when verification of the digital signature is successful in the verification process.

13. An information processing device comprising:
an obtainer that obtains value information owned by a user and indicating a contribution to a natural environment as an environmental value; and
a determiner that determines, according to the environmental value indicated in the value information obtained, a function to be provided to the user who uses a virtual space generated by a computer, and provides, to the user, the function determined.

14. A non-transitory computer-readable recording medium having recorded thereon a program for causing a computer to execute the information processing method according to claim 1.
